(19) United States
(12) Patent Application Publication
(10) Pub. No.: US 2024/0353076 A1
(43) Pub. Date: Oct. 24, 2024

(54) LED Armature and Lighting System Comprising the Same

(71) Applicant: Air Supplies Holland B.V., Amsterdam (NL)

(72) Inventor: Ronald Van de Oudeweetering, Amsterdam (NL)

(21) Appl. No.: 18/684,755

(22) PCT Filed: Aug. 22, 2022
(86) PCT No.: PCT/NL2022/050481

§ 371 Date: Feb. 19, 2024

(30) Foreign Application Priority Data
Aug. 20, 2021 (NL) 2029015

(51) Int. Cl. F21S 4/28; F21V 5/00; F21V 7/00; F21V 29/74; F21Y 103/10; F21Y 113/00; F21Y 115/10

(52) U.S. Cl. CPC F21S 4/28; F21V 5/007; F21V 7/0066; F21V 29/74; F21Y 2103/10; F21Y 2113/00; F21Y 2115/10

(57) ABSTRACT

The present application concerns a light emitting diode, LED, armature and a lighting system comprising a plurality of LED armatures. The LED armature comprises a plurality of first LEDs facing a first direction, and arranged in a line in a second direction, substantially perpendicular to the first direction. For each first LED among the plurality of first LEDs, the armature comprises a reflector substantially facing the first direction, arranged adjacent to that first LED in a third direction, substantially perpendicular to the first and second directions. The armature further comprises a lens elongated in the second direction, of which a receiving side is configured to receive light from the plurality of first LEDs, and of which an emission side is configured to emit, as a bundle, light that was received on the receiving side, and that has passed through the lens. The receiving side of the lens is adapted for reflecting a part of the light emitted by one first LED among the plurality of first LEDs onto the reflector adjacent to that LED, allowing that part of the light to be reflected by that reflector towards the receiving side. The lighting system comprises one or more pairs of substantially parallel frame sections, and, in between each pair of frame sections, a plurality of LED armatures according to the invention. For each pair of frame sections, the LED armatures from the plurality of LED armatures are arranged substantially parallel to each other and/or substantially perpendicularly to each frame section from said pair of frame sections.

The present application concerns a light emitting diode, LED, armature as well as a lighting system comprising a plurality of such LED armatures.

### BACKGROUND OF THE INVENTION

Armatures for LEDs known in the art comprise a plurality of first LEDs facing a first direction, and arranged in a line in a second direction, substantially perpendicular to the first direction. Such armatures further comprise a lens elongated in the second direction, of which a receiving side is configured to receive light from the plurality of first LEDs, and of which an emission side is configured to emit, as a bundle, light that was received on the receiving side, and that has passed through the lens.

As in many applications, when using LEDs as a light source for indoor farming, vertical farming and/or as growth lights, efficiency is of the utmost importance. These applications are notorious for both employing numerous LEDs at the same time, as well as employing LEDs for extensive durations. Even the smallest improvement in efficiency is considered significant as they help save power and therefore reduce costs.

To improve efficiency, it is known that arrange, for each first LED among the plurality of first LEDs, a reflector substantially facing the first direction, arranged adjacent to that first LED in a third direction, substantially perpendicular to the first and second directions.

In the above applications, it is a further goal of providing an area and/or set of objects such as plants, or alternatively seedlings and saplings, with light as uniformly as possible. When providing light to the mentioned flora, providing said light uniformly helps averaging out possible differences in growth rates and ideally leads to these plants being ready for the next step in the growth process at the same time.

It is therefore a goal of the present application to provide a LED armature with increased efficiency. It is a further goal of the application to provide a LED armature that can provide light more uniformly.

### SUMMARY OF THE INVENTION

According to the present invention, this is achieved by providing a LED armature as defined in claim 1 that is characterized in that the receiving side of the lens is adapted for reflecting a part of the light emitted by one first LED among the plurality of first LEDs onto the reflector adjacent to that LED, allowing that part of the light to be reflected by that reflector towards the receiving side.

Light emitted by the first LEDs travels towards the lens and there, part of the light is transmitted into the lens and, inevitably, part of the light is reflected. The ratio between transmission and reflection is in part determined by the angle at which light arrives at the lens, wherein the most light is transmitted and/or the least light is reflected when light arrives at the receiving surface of the lens at precisely a ninety degree angle.

Would a lens be provided with a receiving surface that receives light emitted by a LED at this ninety degree angle, reflections would be minimal. However, the inevitable reflections that are present will also travel back from the lens at a ninety degree angle—i.e. directly back towards the LED. The LED in question will absorb most of, if not effectively all of the reflected light. In an armature according to the present invention, the lens is provided with a receiving side adapted for reflecting towards a reflector. This light is therefore not absorbed by the LED but is in turn reflected back to the lens, thereby reducing losses occurring due to the earlier described effect and increasing efficiency of the armature as a whole.

The abovementioned improvement of efficiency is directly related to how much of the light reflected by the receiving side is reflected by the reflector back to the receiving side, so this is preferably 50% or more.

In a particular embodiment, the receiving side, in a cross-sectional plane perpendicular to the second direction, is described by one or more curves, wherein a first curve among the one or more curves is shaped such that light, emitted by said one first LED that falls onto the part of the receiving side described by the first curve, is partially reflected towards the reflector adjacent to that one first LED.

The LED armatures having such a receiving side preferably further comprising, for each first LED among the plurality of first LEDs, a further reflector facing the first direction, arranged adjacent to that first LED, opposite to the reflector.

In some preferred embodiments, the first curve is a parabola and the line in which the first LEDs are arranged, intersects perpendicularly with the parabola's axis of symmetry.

In other preferred embodiments, the receiving side, in the cross-sectional plane perpendicular to the second direction, is described by a plurality of curves. The second curve among the plurality of curves, adjoining the first curve, is shaped such that light emitted by said one first LED that falls onto the part of the receiving side described by the second curve, is partially reflected towards the further reflector adjacent to that one first LED. Preferably, the first and second curves are circular arcs of which the origins are arranged at the reflector, and the further reflector respectively. Even more preferably, each of the two circular arcs has an angle between 90 and 180 degrees, preferably between 95 and 135 degrees.

In some preferred embodiments, the lens has a substantially constant cross-section in the second direction.

To reduce the cost of manufacturing armatures, the line of first LEDs may be a LED strip.

To be able to quickly install and/or replace, the line of first LEDs may be arranged on a plate.

The LED armature may further comprise an armature frame having a cross-section approximately constant in the second direction. The armature frame may comprise a cross-section approximately constant in the second direction. Such an armature frame preferably comprises a pair of oppositely arranged guiding grooves in which edges of the plate are arranged.

In some embodiments, the LED armature further comprises one or more cooling elements configured to conduct heat generated by the first LEDs away from the respective LEDs, and/or the cooling elements can be arranged on a side of the armature frame opposite to the side on which the first LEDs are arranged. This allows for larger densities of LEDs to be used without damaging said LEDs and/or other (electronic) components in the armature.

In some embodiments, the first LEDs are wide spectrum LEDs, preferably white light LEDs.

In an embodiment, the armature may further comprise a plurality of second LEDs arranged in a line. In this embodiment, the lens comprises a beam shaping part, wherein the beam shaping part comprises the receiving side configured to receive light from the plurality of first LEDs, and the emission side configured to emit, as a bundle, light that was received on the receiving side, and that has passed through the beam shaping part. In this embodiment, the lens further comprising a diffusing part, the diffusing part being configured to receive light from the line of second LEDs, to internally guide said light, while allowing said light to diverge in the second direction, into the beam shaping part such that said light is emitted from the emissions side thereof.

The skilled person will appreciate that the abovementioned LED armature may include a lens comprising the beam shaping part and the diffusing part, without also comprising the receiving side shaped as discussed earlier. Specifically said, the invention at least partially solves the mentioned object by providing a LED armature comprising a plurality of second LEDs arranged in a line. The lens further comprises a beam shaping part and a diffusing part. The beam shaping part comprises the receiving side configured to receive light from the plurality of first LEDs, and the emission side configured to emit, as a bundle, light that was received on the receiving side, and that has passed through the beam shaping part. The diffusing part is configured to receive light from the line of second LEDs, to internally guide said light while allowing said light to diverge in the second direction and/or in a direction opposite to the second direction, into the beam shaping part such that said light is emitted from the emissions side thereof.

Allowing light emitted by the second LEDs to diverge in the second direction ensures that, once emitted from the emission side of the beam shaping part, said light will be emitted more evenly spread—e.g. more uniformly—in the second direction, than if said light would have travelled through just the beam shaping part of the elongated lens.

The following embodiments specify features which are optional for both of the two abovementioned armatures in which the lens comprises a beam shaping part and a diffusing part.

In some preferred embodiments, the diffusing part is further configured to prevent and/or limit divergence of light received from the line of second LEDs in directions perpendicular to the second direction. Light of the second LEDs is then not spread out in, for example, the third direction when exiting the beam shaping part. This preferred embodiment illuminates a well defined, elongated area particularly uniformly.

In some preferred embodiments, wherein the diffusion part is configured to internally guide light received from the line of second LEDs over a distance inversely related to, preferably approximately inversely proportional to a distance between adjacent second LEDs in the line that they are arranged in. Would the diffusing part internally guide light over a distance relatively small in relation to the distance between adjacent second LEDs, beams of light emitted by the individual LEDs may not have diverged in the second direction sufficiently and, once these beams of light exit the beam shaping part of the lens, the beams perhaps still do not overlap. In this case, dark spots may exist between the areas of the beam shaping part of the lens where the individual beams exit.

In some preferred embodiments, the beam shaping part and the diffusing part are formed as a single, monolithic body and/or are formed from a single extrusion profile. Such manufacturing processes are robust and allow for cheap manufacturing of the lens.

In some preferred embodiments, the line of first LEDs comprises a first number of first LEDs per unit of distance, and/or wherein the line of second LEDs has a second number of LEDs per unit of distance, preferably smaller than the first number. For this embodiment the diffusing part is particularly useful as it may allow for the line of second LEDs to, specifically considering the distribution of light in the second direction, emit light with a uniformity closer to the light emitted by the more numerous first LEDs and/or more densely arranged line of first LEDs.

In some embodiments, the line of second LEDs is arranged parallel to the line of first LEDs. When the shortest distance between the line of first LEDs and the line of second LEDs is always the same, a simpler lens design can be used.

To further simplify installing the LEDs, the line of first LEDs and the line of second LEDs may be arranged on one plate. In some embodiments, the second LEDs also face the first direction and/or the line of second LEDs is a LED strip.

In some embodiments, the second LEDs are configured to emit light in a range of wavelengths different from the first LEDs. Plants may require light from varying wavelengths with varying intensities. However, emitting light uniformly is still important and optimal placement of the armature may be the same for these varying wavelengths. By first allowing the light of the second LEDs to diffuse, light from one second LED is spread out. By directing it into the beam shaping part, it is emitted in approximately the same direction as light from the first LEDs. In some embodiments, the second LEDs are at least one of narrow spectrum LEDs, LEDs of which the colour can be selected, and/or LEDs configured to emit green light and/or to emit light with a wavelength in the range of 500 to 580 nanometre, and preferably around 550 nanometre.

According to a further aspect of the invention, a lighting system is provided comprising one or more pairs of substantially parallel frame sections, and, in between each pair of frame sections, one or more LED armatures according to any of the preceding claims. For each pair of frame sections, the one or more LED armatures are arranged substantially parallel to each other and/or substantially perpendicularly to each frame section from said pair of frame sections.

In a preferred embodiment, the system comprises two or more pairs of substantially parallel frame sections, wherein a first pair of frame sections is hingedly attached to a second pair of frame sections, allowing the first pair of frame sections and the second pairs of frame sections to pivot in relation to each other along an axis substantially perpendicular to each of the frame sections from the first and second pairs of frame sections and/or substantially parallel to each of the LED armatures in between the first and/or the second pair of frame sections.

This hinged connection is provided in a preferred embodiment by the first pair of frame sections comprising a first and a second frame section; and the second pair of frame sections comprising a third and a fourth frame section. A first end of the first frame section and a first end of the third frame section are hingedly connected. A first end of the second frame section, being an end of the second frame section on the same side of the first pair of frame sections as the first end of the first frame section, and a first end of the fourth frame section, being an end of the fourth frame section on the same side of the second pair of frame sections as the first end of the third frame sections, are also hingedly connected.

### DESCRIPTION OF THE FIGURES

Further preferred embodiments of the present invention and particular advantages thereof will be further discussed in relation to the accompanying figures, wherein:

FIG. 1 shows a system comprising a plurality of LED armatures according to the invention;

FIG. 2 shows a schematic cross-section of an embodiment of a LED armature according to the invention;

FIG. 3 shows a schematic cross-section, perpendicular to the cross-section shown in FIG. 2, of an embodiment of a LED armature according to the invention;

FIG. 4 shows a schematic cross-section in a plane similar or equal to that of FIG. 2, of an embodiment of a LED armature according to the invention; and

FIG. 5-6 show light patterns affected by lenses which may be included in LED armatures according to the invention;

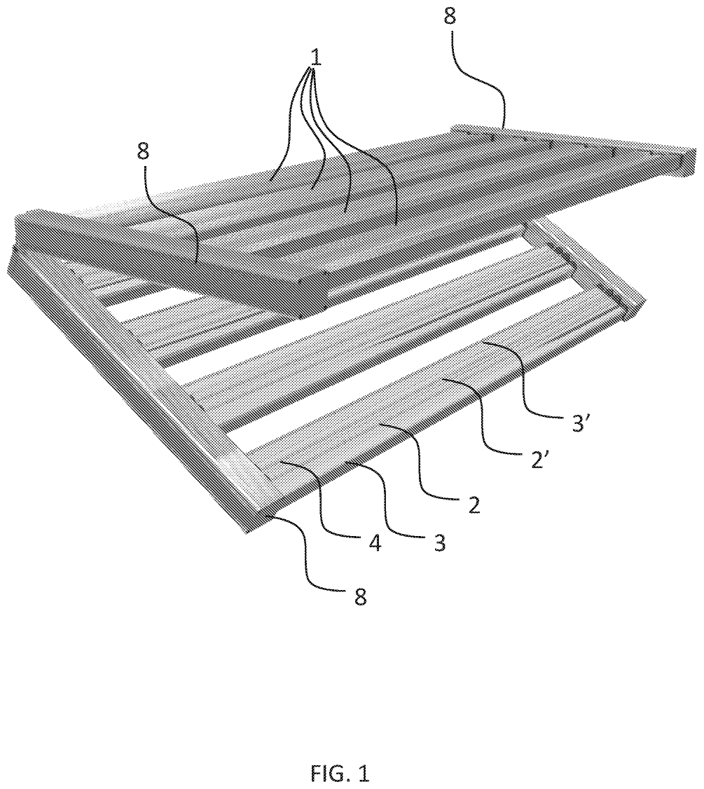

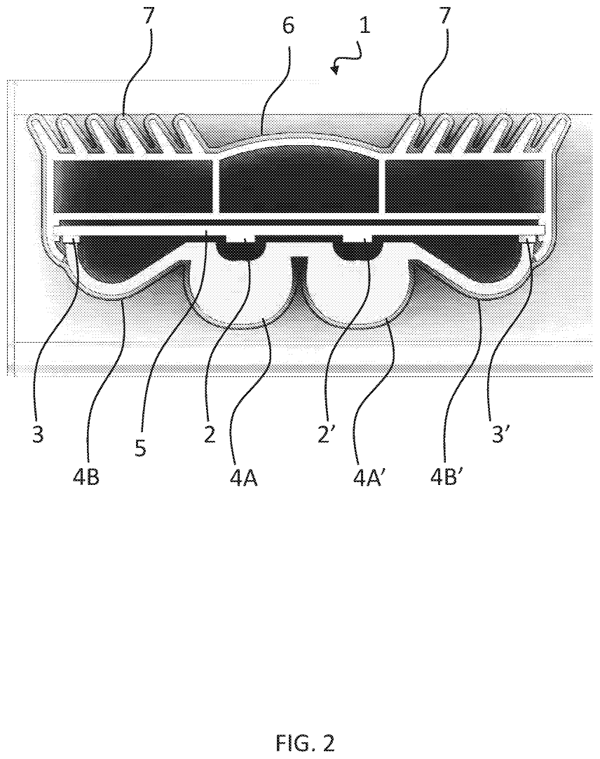

Referring to FIG. 1, a system comprising a total of eight LED armatures 1 is shown. This embodiment in particular further comprises two pairs of perpendicular frame parts 8. The perpendicular frame parts forming a pair together flank four LED armatures 1. Each frame part is hingedly attached, on one end, with another frame part that it does not form a pair with.

The skilled person will appreciate that any number of LED armatures 1 may be included in such a system, and that LED armatures 1 may also be mutually coupled by a frame part on just one side of the armatures 1 or by pairs of frame parts 8 not perpendicular to each other. Additionally, embodiments are conceivable in which frame parts 8 are not necessary at all, for example when the system comprises a single LED armature 1.

As shown, LED armature 1 comprises a plurality of first LEDs 2, 2′ as well as a plurality of second LEDs 3,3′. Armature 1 further comprises a lens 4 arranged in front of each of these pluralities of LEDs. First LEDs 2,2′ are in this case arranged in a first line of first LEDs 2 and a second line of first LEDs 2′, but any number of lines is possible. Second LEDs 3, 3′ are in this case arranged in a first line of second LEDs 3 and a second line of second LEDs 3′, but any number of lines is possible.

While the system shown generally consists of two parts hingedly attached to one another in the way explained before, the system may consist of just one part, or three or more parts hingedly attached to other parts in a chain.

Referring to FIG. 2, a cross-section of an embodiment of LED armature 1 according to the invention is shown. Specifically, the cross-section shown is in a plane perpendicular to the lines of first LEDs 2, 2′ and the lines of second LEDs 3, 3′ also shown in FIG. 1. In principle, FIG. 2 shows a cross-section of only one part of LED armature 1. However this cross-sections is in fact representative for most of LED armature 1 because such armatures tend to have an essentially constant cross-section in the second direction and/or along their entire length, or they at least have a shape wherein variations in the cross-section over the length of the armature may be minimal and, if any, have only an insubstantial effect on the properties of the armature.

Additionally, FIG. 2 shows a plate 5 on which the LEDs 2, 2′, 3, 3′ are mounted and an armature frame 6 in which plate 5 is arranged. Armature frame 6 is provided with cooling fins 7 that help dissipate heat generated by the LEDs 2, 2′, 3, 3′, as well as by any other (electronic) components included in LED armature 1.

The plurality of first LEDs 2, 2′ is arranged to emit light towards lens 4. The direction in which first LEDs 2, 2′ from the first and second lines of first LEDs 2, 2′ emit light is also referred to as the first direction. It is not essential that each first LED 2, 2′ emits light in exactly the first direction or in exactly the same direction as all of the other first LEDs 2, 2′. Minor variations may occur.

While FIG. 2 effectively shows only two schematic indications of first LEDs 2, 2′ and two schematic indications of second LEDs 3, 3′, each of these schematic indications represents a line of LEDs extending in a direction substantially perpendicular to the cross-section shown. The direction in which the lines of first LEDs 2, 2′ extend is also referred to as the second direction.

The skilled person will appreciate that each line of first LEDs 2, 2′ defines its respective ‘first direction,’ and ‘second direction.’ Further directions defined in relation to a particular line of first LEDs 2, 2′ can therefore be defined in terms of, or in relation to the first direction and second direction without these further directions being limited in their relation to other lines of first LEDs 2, 2′ present in LED armature 1 or in a system comprising a plurality of LED armatures 1.

In the embodiment shown, both lines of second LEDs 3, 3′ are arranged on plate 5 at a distance from the lines of first LEDs 2, 2′. The lines of second LEDs 3, 3′ may be parallel to each other and/or each line may be parallel to one or both of the lines of first LEDs 2, 2′ but other mutual arrangements are also possible. In the embodiment shown, the second LEDs 3, 3′ are arranged to emit light in the first direction but this is not essential.

Lens 4 as shown in FIG. 1 is specified in FIG. 2 as comprising two main lens bodies referred to as the beam shaping parts 4A, 4A′ of lens 4. Additionally, lens 4 is shown as comprising two side lens bodies referred to as the diffusing parts 4B, 4B′. Embodiments in which lens 4 comprises one beam shaping part 4A, and/or one diffusing part 4B are also conceivable.

In the embodiment shown, beam shaping part 4A is arranged in front of the line of first LEDs 2. Beam shaping part 4A receives light that is emitted by the first LEDs in the first direction. This light travels through beam shaping part 4A, and is emitted from an emission side of beam shaping part 4A in a bundle of light.

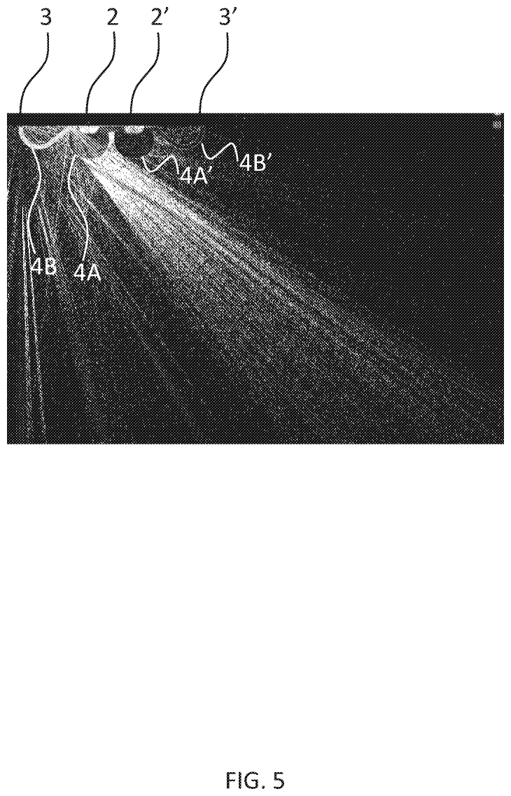

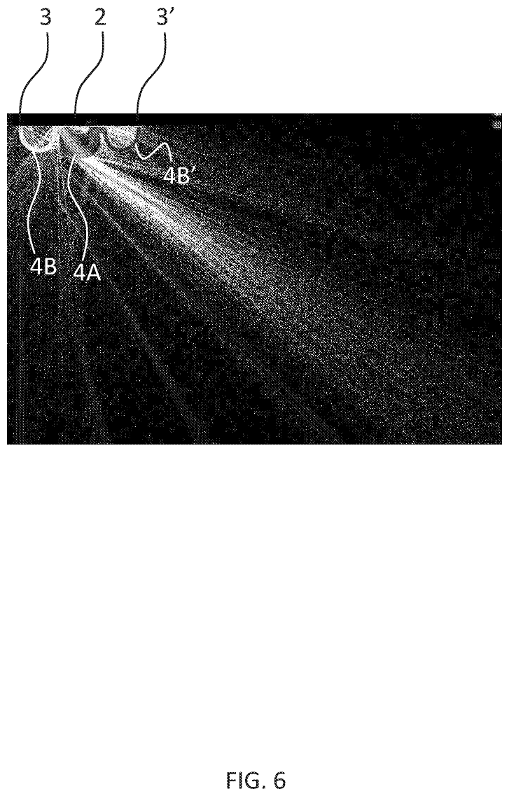

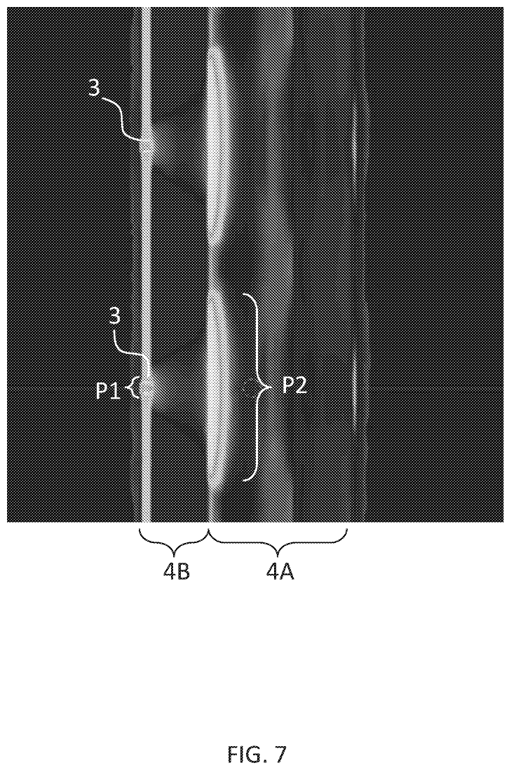

Diffusing part 4B is arranged in front of line of second LEDs 3. The effect that lens 4, and in particular diffusing part 4B, has on light emitted by second LEDs 3 is shown in FIGS. 5 and 6. In FIG. 5, lens 4 comprises beam forming parts 4A, 4A′ and diffusing parts 4B, 4B′. In FIG. 6, lens 4 comprises just beam forming part 4A. Both FIGS. 5 and 6 show a pattern that light emitted by second LEDs 3 makes when being internally guided by diffusing part 4B towards beam shaping part 4A. In this embodiment, light enters diffusing part 4B because a receiving surface thereof is arranged directly in front, and facing second LEDs 3. Light emitted by second LEDs 3 arrives at said receiving surface at an angle of approximately 90 degrees, or at an angle of 60 degrees or more, or at least at an angle of 45 degrees or more. In this embodiment, light is internally guided by diffusing part 4B into the beam shaping part 4A because of the light curve along which diffusing part 4B extends from the receiving surface towards the beam shaping part 4A.

As can be seen from FIGS. 5 and 6, light is internally guided by the diffusing part 4B and does not, or at least barely, diverge in directions perpendicular to the second direction.

As the mutual arrangement between first LEDs 2 and second LEDs 3 may vary so may the shape and size of diffusing part 4B. Any particular shapes and sizes shown in the figures and discussed in the description are merely examples.

The skilled person will appreciate that in this application a bundle of light can refer to a beam of light having no particular shape and/or size, but which does travels in a general direction while diverging less than when it was just emitting from its source and/or before it travelled through any beam shaping part, for example either of the beam shaping parts 4A, 4A′.

There is a number of advantages to mounting all of the LEDs in question on a single plate 5 as shown in FIG. 2. It is for example easier to install, and equivalently, easier to remove all of the LEDs at the same time if significant repairs or complete replacement is required. Additionally, the number of connectors required may be less. However, the skilled person will appreciate that plate 5 may also be embodiment by a plurality of plates. Each line may be mounted on a respective plate, in which case the plates may be elongated and arranged parallel to each other, mutually aligned in a direction perpendicular to the direction of the line of first or second LEDs. Or, two or more plates can each have a part of one or more lines mounted thereon. In that case, these plates are arranged in a line and/or mutually aligned in the direction of the one or more lines mounted on these plates. Finally, it is also possible to mount every LED on its respective plate 5.

In the embodiment shown in FIG. 2, cooling fins 7 are shown in a side of armature frame 6 opposite to the side on which the LEDs are arranged. While this is preferable, embodiments are conceivable in which cooling fins, or any other implementation of a heat sink, are mounted to either of the sides of armature frame 6 shown, or on outer ends of armature frame 6 not shown. Ultimately, cooling fins 7 (or any heat sink, for that matter) may not be necessarily required.

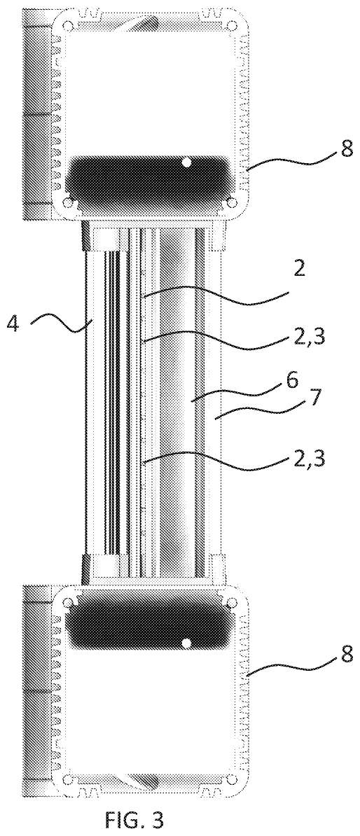

Referring to FIG. 3, a cross-section of a system comprising an embodiment of a LED armature 1 according to the invention is shown. Similarly to the embodiment shown in FIG. 2, LED armature 1 comprises a line of first LEDs 2, a line of second LEDs 3, and lens 4. LED armature 1 further comprises armature frame 6 provided with cooling fins 7. Similarly to the system shown in FIG. 1, LED armature 1 is flanked by frame parts 8.

Specifically, the cross-section shown is one in a plane spanned by vectors in the first and second direction. From this cross-section, it can be seen that first LEDs 2 are arranged in a line and that second LEDs 3 are also arranged in a line. In this embodiment, the line of first LEDs comprises a total twelve first LEDs and the line of second LEDs comprises a total of two LEDs. However, any other number of LEDs may be used to form the line of first LEDs 2 and the line of second LEDs 3.

FIG. 7 shows a view of LED armature 1, specifically of second LEDs 3 and lens 4 from a direction opposite to the first direction. That is, the first direction points out of the page. Second LEDs 3 emit light in a direction pointing out of the page. It follows from the direction in which lens 4 is elongated that, in this embodiment and seen from this perspective, the second direction corresponds to the vertical direction. As shown in FIG. 7, light emitted by a second LED 3 arrives at one end of the diffusing part 4B with a first profile P1. In this embodiment, the dimension of this profile that is particularly relevant is the length in the second direction. Due to the elongated shape of the lens, specifically the elongated shape of diffusing part 4B, while received light is internally guided through said diffusing part 4B it diverges in the second direction. Therefore, light arrives at the other end of the diffusing part 4B with a second profile P2 that is elongated in the second direction with respect to first profile P1. As was explained in relation to FIGS. 5 and 6, diffusing part 4B prevents and/or limits divergence of light received from the line of second LEDs 3 in directions perpendicular to the second direction.

Referring back to FIG. 7, in the embodiment shown the line of first LEDs 2 comprises a larger number of LEDs than the equally long line of second LEDs 3. Light emitted by the line of first LEDs 2 arrives at the receiving side of beam shaping part 4A according to a particular distribution. Preferably, first LEDs 2 illuminate a contiguous area of this receiving side. However, it is also possible that first LEDs are not arranged near enough to each other and/or to close to the receiving side. In this case, first LEDs 2 illuminate non-overlapping areas of the receiving side and/or there are dark spots between the areas of the receiving side illuminated by first LEDs 2 which are adjacent in the line. When the line of first LEDs is arranged at a given distance from lens 4, the skilled person can determine the number of first LEDs required for the beam of light provided by LED armature 1 as a whole to be substantially uniform in the second direction. As light from second LEDs 3 is first received by and internally guided through diffusing part 4B, the number of second LEDs required for the beam of light provided by armature 1 as a whole to be equally uniform will be lower. Alternatively, in an embodiment of LED armature 1 comprising a line of second LEDs 3 which is the same as, or at least substantially the same as its line of first LEDs 2, turning on the line of second LEDs will allow for armature 1 to provide a beam of light more uniform in the second direction then when the line of first LEDs is turned on.

Lens 4 may be made of a particularly transparent material such as polymethylmethacrylate, ‘PMMA.’ Other materials may also be used. Lens 4 may be made by extruding a base material such as PMMA into an elongated body having a cross-section as discussed in relation to FIG. 2, or any of the mentioned alternatives. Armature frame 6, as well as frame parts 8 may be made of aluminium, or one or more of any of the suitable materials.

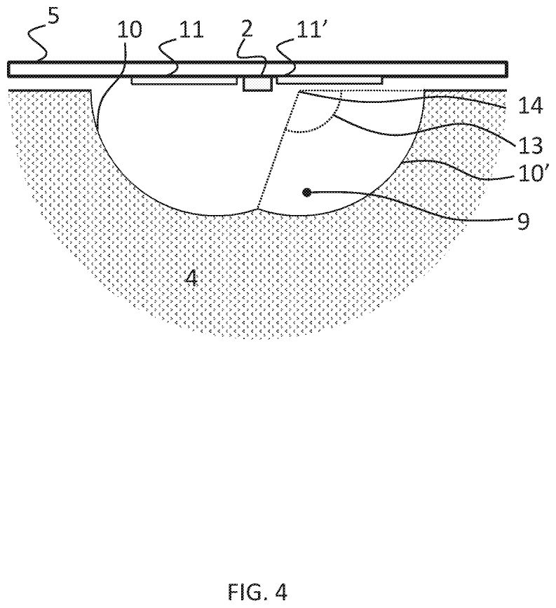

Referring to FIG. 4, LED armature 1 again comprises a plate 5 on which is arranged a line of first LEDs 2. In front thereof is arranged lens 4. The cross-section shown in FIG. 4 corresponds to the cross-section (or, is a cross-section in a plane parallel to the cross section) shown in FIG. 2.

While it is common in the art to say that LEDs emit light in a particular direction, the skilled person is aware that this is not just one direction but that LEDs emit in a steradian. To arrange a LED directly in front of a flat surface results in part of the light emitted by this LED to arrive at the surface at an angle causing a part of this light to be reflected. As the efficiency of LED armature 1 as a whole is directly related to how much of the light emitted by first LEDs 2 is transmitted into lens 4, specifically beam shaping part 4A, there is an incentive to provide a receiving surface that receives light from the first LEDs at an angle as small as possible.

However, because an actual LED is not a point source, at least some light will always arrive at the receiving surface at an angle. Receiving surfaces designed according to just the abovementioned requirement reflect light back onto first LED 2. Because first LED 2 is not reflective itself, light reflected back onto first LED 2 is absorbed by LED 2 and is consequently lost.

LED armature 1 shown in FIG. 4, and specifically lens 4 is provided with a groove 9 of which the inside surface acts as a receiving side 10, 10′. Adjacent to LED 2 is/are one or more reflectors 11, 11′. In this embodiment in particular, two reflectors 11, 11′ flank first LED 2 in a third direction, perpendicular to the first and second directions. It is also possible to use just one reflector on one side of LED 2, or to use a plurality of reflectors arranged on either side of LED 2. Each reflector 11, 11′ is arranged at a distance from first LED 2 and faces the first direction. The reflector may also face other directions. The shape of groove 9 is adapted for reflecting light emitted by first LED 2 towards either of these reflectors 11, 11′. Consequently, a part of the light emitted by first LED 2 that is reflected by receiving sides 10, 10′ of lens 4 is not reflected directly back at said first LED 2 but to the reflectors 11, 11′. The reflectors, in turn, reflect said light back towards lens 4. This increases the overall efficiency of LED armature 1. Efficiency in this case may be defined as how much light is transmitted in relation to the power consumed by armature 1, or by the system as a whole.

Embodiments of receiving side 10, 10′ having various shapes and sizes that achieve this effect can be conceived and the embodiment shown in FIG. 4 is merely exemplary. In said embodiment, the receiving side is ‘broken up’ in two sections. Both a first section 10 and a second section 10′ have a shape that in the plane shown in FIG. 4 correspond to a circle arc. Specifically, shown are circle arcs of a particular angle 13 somewhat larger than 90 degrees. For each circle arc, its centre 14 is arranged adjacent to LED 2 and/or at one of the reflectors, respectively. However, other geometric shapes are also possible.

The skilled person will appreciate that LED armature 1 may include a lens 4 comprising the beam shaping part and the diffusing part as described in relation to FIGS. 2-3, and 5-7, and without the receiving side as discussed in relation to FIG. 4. That is, in a particular embodiment the armature comprises a plurality of first LEDs facing a first direction, and arranged in a line in a second direction, substantially perpendicular to the first direction, for each first LED among the plurality of first LEDs, a reflector substantially facing the first direction, arranged adjacent to that first LED in a third direction, substantially perpendicular to the first and second directions, and a lens elongated in the second direction, of which a receiving side is configured to receive light from the plurality of first LEDs, and of which an emission side is configured to emit, as a bundle, light that was received on the receiving side, and that has passed through the lens. In this particular embodiment, the armature further comprises a plurality of second LEDs arranged in a line. The lens further comprises a beam shaping part and a diffusing part. The beam shaping part comprises the receiving side configured to receive light from the plurality of first LEDs, and the emission side configured to emit, as a bundle, light that was received on the receiving side, and that has passed through the beam shaping part. The diffusing part is configured to receive light from the line of second LEDs, to internally guide said light while allowing said light to diverge in the second direction and/or in a direction opposite to the second direction, into the beam shaping part such that said light is emitted from the emissions side thereof.

In the above, the present invention has been described using detailed embodiments thereof. However, the present invention is not limited to these embodiments. Various modifications to the embodiments are possible without deviating from the scope of the present invention, which is defined by the appended claims and their equivalents.

1.-25. (canceled)

26. A light emitting diode, LED, armature comprising:
a plurality of first LEDs facing a first direction, and arranged in a line in a second direction, substantially perpendicular to the first direction;
for each first LED among the plurality of first LEDs, a reflector substantially facing the first direction, arranged adjacent to that first LED in a third direction, substantially perpendicular to the first and second directions, and a further reflector substantially facing the first direction and arranged adjacent to said first LED in a direction opposite to the third direction; and
a lens elongated in the second direction, of which a receiving side is configured to receive light from the plurality of first LEDs, and of which an emission side is configured to emit, as a bundle, light that was received on the receiving side, and that has passed through the lens,
wherein the receiving side of the lens is adapted for reflecting a part of the light emitted by one first LED among the plurality of first LEDs onto the reflector adjacent to that LED, allowing that part of the light to be reflected by that reflector towards the receiving side,
wherein the receiving side, in the cross-sectional plane perpendicular to the second direction, is described by a plurality of curves,
wherein a first curve among the plurality of curves is shaped such that light, emitted by said one first LED that falls onto the part of the receiving side described by the first curve, is partially reflected towards the reflector adjacent to that one first LED,
wherein a second curve among the plurality of curves, adjoining the first curve, is shaped such that light emitted by said one first LED that falls onto the part of the receiving side described by the second curve, is partially reflected towards the further reflector adjacent to that one first LED,
wherein the first and second curves are circular arcs of which the origins are arranged at the reflector, and the further reflector respectively, and
wherein each of the two circular arcs has an angle between 90 and 180 degrees.

27. The LED armature according to claim 26, wherein at least 50% of the light reflected by the receiving side, is reflected by the reflector back to the receiving side.

28. The LED armature according to claim 26, wherein the cross-section of the lens is substantially constant in the second direction.

29. The LED armature according to claim 26, wherein the line of first LEDs is a LED strip.

30. The LED armature according to claim 26, wherein the line of first LEDs is arranged on a plate.

31. The LED armature according to claim 26, further comprising an armature frame having a cross-section approximately constant in the second direction.

32. The LED armature of claim 30, wherein the armature frame comprises a pair of oppositely arranged guiding grooves in which edges of the plate are arranged.

33. The LED armature of claim 31, further comprising one or more cooling elements configured to conduct heat generated by the first LEDs away from the respective LEDs, and/or wherein the cooling elements are arranged on a side of the armature frame opposite to the side on which the LEDs are arranged.

34. The LED armature according to claim 26, wherein the first LEDs are wide spectrum LEDs, preferably white light LEDs.

35. The LED armature according to claim 26, further comprising:
a plurality of second LEDs arranged in a line,
wherein the lens comprises a beam shaping part, wherein the beam shaping part comprises the receiving side configured to receive light from the plurality of first LEDs, and the emission side configured to emit, as a bundle, light that was received on the receiving side, and that has passed through the beam shaping part, and
wherein the lens further comprising a diffusing part, wherein the diffusing part is configured to receive light from the line of second LEDs, to internally guide said light while allowing said light to diverge in the second direction and/or in a direction opposite to the second direction, into the beam shaping part such that said light is emitted from the emissions side thereof.

36. The LED armature according to claim 35, wherein the diffusing part is further configured to prevent and/or limit divergence of light received from the line of second LEDs in directions perpendicular to the second direction.

37. The LED armature according to claim 35, wherein the diffusion part is configured to internally guide light received from the line of second LEDs over a distance related to, preferably approximately proportional to, a distance between adjacent second LEDs.

38. The LED armature according to claim 35 wherein the beam shaping part and the diffusing part are formed as a single, monolithic body and/or are formed from a single extrusion profile.

39. The LED armature according to claim 35, wherein the line of first LEDs comprises a first number of first LEDs per unit of distance, and/or wherein the line of second LEDs has a second number of LEDs per unit of distance, preferably smaller than the first number.

40. The LED armature according to claim 35, wherein the line of second LEDs is arranged parallel to the line of first LEDs.

41. The LED armature according to claim 35, wherein the second LEDs also face the first direction.

42. The LED armature according to claim 35, wherein the line of second LEDs is a LED strip.

43. The LED armature according to claim 35, wherein the line of first LEDs and the line of second LEDs are arranged on one plate.

44. The LED armature according to claim 35, wherein the second LEDs are configured to emit light in a range of wavelengths different from the first LEDs.

45. The LED armature according to claim 35, wherein the second LEDs are at least one of narrow spectrum LEDs, LEDs of which the colour can be selected, and/or LEDs configured to emit green light and/or to emit light with a wavelength in the range of 500 to 580 nanometre.

46. A lighting system comprising:
one or more pairs of substantially parallel frame sections; and
in between each pair of frame sections, one or more LED armatures according to any of the preceding claims,
wherein, for each pair of frame sections, the one or more LED armatures are arranged substantially parallel to each other and/or substantially perpendicularly to each frame section from said pair of frame sections.

47. The lighting system according to claim 26, comprising two or more pairs of substantially parallel frame sections,
wherein a first pair of frame sections is hingedly attached to a second pair of frame sections, allowing the first pair of frame sections and the second pairs of frame sections to pivot in relation to each other along an axis substantially perpendicular to each of the frame sections from the first and second pairs of frame sections and/or substantially parallel to each of the LED armatures in between the first and/or the second pair of frame sections.

48. The lighting system of claim 47, wherein:
the first pair of frame sections comprises a first and a second frame section; and
the second pair of frame sections comprises a third and a fourth frame section,
wherein a first end of the first frame section and a first end of the third frame section are hingedly connected, and
wherein a first end of the second frame section, being an end of the second frame section on the same side of the first pair of frame sections as the first end of the first frame section, and a first end of the fourth frame section, being an end of the fourth frame section on the same side of the second pair of frame sections as the first end of the third frame sections, are also hingedly connected.
